(19) United States
(12) Patent Application Publication
(10) Pub. No.: US 2005/0280949 A1
(43) Pub. Date: Dec. 22, 2005

(54) Head-drum assembly for magnetic recording/reproducing apparatus, and a method of manufacturing a head-drum assembly

(75) Inventors: Jae-Hoon Sim, Suwon-si (KR); Jun-Young Kim, Suwon-si (KR); Hyeong-Seok Choi, Suwon-si (KR); Jeong-Seon Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/151,529

(22) Filed: Jun. 14, 2005

(30) Foreign Application Priority Data
Jun. 17, 2004 (KR) 2004-44806

(51) Int. Cl. G11B 5/52

(52) U.S. Cl. 360/271.6

(57) ABSTRACT

A head-drum assembly for a magnetic recording/reproducing apparatus, and a method of manufacturing a head/drum assembly, with a simplified setup structure of a fixed drum on a main chassis are provided, where a shaft is inserted into a fixed drum and has a connection unit at least a portion of which protrudes from the lower part of the fixed drum, a rotary drum is disposed on the upper part of the fixed drum and supported by the shaft to be rotatable, a drum base has an opening which the portion of the connection unit penetrates, and a connection housing is connected with the portion of the connection unit on, for example, opposite surface of the drum base.

### CROSS-REFERENCE TO RELATED APPLICATIONS

This application claims the benefit under 35 U.S.C. §119(a) of Korean Patent Application No. 2004-44806 filed Jun. 17, 2004, in the Korean Intellectual Property Office, the entire disclosure of which is hereby incorporated by reference.

### BACKGROUND OF THE INVENTION

1. Field of the Invention

The present invention relates to a head-drum assembly for a magnetic recording/reproducing apparatus.

2. Description of the Related Art

Generally, a magnetic recording/reproducing apparatus records video and audio data on a recording medium such as a magnetic tape and reproduces the recorded data. Examples of magnetic recording/reproducing apparatuses include video cassette tape recorders (VCRs) and camcorders.

The magnetic recording/reproducing apparatus comprises a main chassis, a sliding sub-chassis formed in the main chassis, a head-drum assembly for recording/reproducing data in magnetic tape, and a tape guide for guiding the running of the magnetic tape.

The head-drum assembly is rotatably formed and inclined by a predetermined angle with respect to the main chassis in order to improve a performance of the recording/reproducing. As shown in FIGS. 1 and 2, the head-drum assembly comprises a fixed drum 11, a shaft 10 inserted into the fixed drum 11 with pressure, a rotary drum 13 formed on the shaft 10 to be rotatable in the upper part of the fixed drum 11, a drum cover 14 fixed on the upper part of the rotary drum 13, and a magnetic head 15 mounted to the rotary drum 13.

The magnetic head 15 records data on the magnetic tape that runs in contact with the external circumferential surfaces of the fixed drum 11 and the rotary drum 13, or reproduces data from the tape.

As illustrated in FIGS. 1 and 2, the fixed drum 11 comprises three screw openings 11a and two guide grooves 11b. As described above, the conventional head-drum assembly assembles the fixed drum 11 by connecting the screw openings 16a of the main chassis 16 and the screw openings 11a of the fixed drum 11 with screws 18, while the bottom surface of the fixed drum 11 is tightly adhered to the main chassis 16. Herein, an elastic material 19 is set up between the screws 18 and the main chassis 16 to protect the head-drum assembly from being deformed by the connection force of the screws 18. The two guide grooves 11b of the fixed drum 11 accommodate guide protrusions of the main chassis 16 (not shown).

However, since the conventional head-drum assembly sets up the fixed drum 11 in the main chassis 16 using arrangement 17, which includes the three screws 18 and the elastic material 19, there are problems in that the productivity is low and the production cost is high because a lot of component parts and manufacturing processes are required.

Accordingly, there is a need for improved arrangement of head-drum assembly utilizing fewer component parts and manufacturing processes.

### SUMMARY OF THE INVENTION

It is, therefore, an object of the present invention to provide a head-drum assembly for a magnetic recording/reproducing apparatus with a simplified assembly structure in a main chassis, and a method of manufacturing thereof.

In accordance with an aspect of the present invention, there is provided a head-drum assembly for a magnetic recording/reproducing apparatus, which comprises a fixed drum, a shaft forcibly inserted into the fixed drum and having a connection unit in a protrusion from the lower part of the fixed drum, a rotary drum disposed in the upper part of the fixed drum and rotatably supported by the shaft, a drum base having an opening through which the protrusion of the shaft penetrates, and a connection housing to be connected with the connection unit from the other surface of the drum base.

According to another aspect of an embodiment of the present invention, head-drum assembly further comprises a guide for guiding the fixed drum to a setup position, and the guide comprises at least a pair of guide bosses formed in the drum base, and boss housings formed in the fixed drum at positions corresponding to the guide bosses or it comprises at least a pair of guide bosses formed in the fixed drum, and boss housings formed in the drum base at positions corresponding to the guide bosses.

According to yet another aspect of an embodiment of the present invention, guide bosses are symmetrically formed with each other with respect to the shaft.

Further, according to yet another aspect of an embodiment of the present invention, the guide bosses are integrally formed with the drum base through a drawing process.

Further, according to yet another aspect of an embodiment of the present invention, the drum base is integrally formed with a main chassis where various parts of the magnetic recording/reproducing apparatus are mounted.

Another exemplary embodiment of the present invention provides a method of manufacturing a head-drum assembly for a magnetic recording/reproducing apparatus, which comprises forcibly inserting a shaft into a fixed drum, the shaft having a connection unit in a protrusion from the lower part of the fixed drum, disposing a rotary drum in the upper part of the fixed drum to be rotatably supported by the shaft, providing a drum base having an opening through which the protrusion of the shaft penetrates, and connecting a connection housing with the connection unit from the other surface of the drum base.

### BRIEF DESCRIPTION OF THE DRAWINGS

The above aspects and features of the present invention will be more apparent by describing certain embodiments of the present invention with reference to the accompanying drawings, in which:

FIGS. 1 and 2 show a conventional head-drum assembly for a magnetic recording/reproducing apparatus and an assembly structure thereof;

FIG. 3 is a side view illustrating a head-drum assembly for a magnetic recording/reproducing apparatus and an assembly structure thereof in accordance with an embodiment of the present invention;

FIG. 4 is an exploded perspective view of FIG. 3; and

FIG. 5 is an exploded perspective view depicting the head-drum assembly for a magnetic recording/reproducing apparatus and an assembly structure thereof in accordance with another embodiment of the present invention.

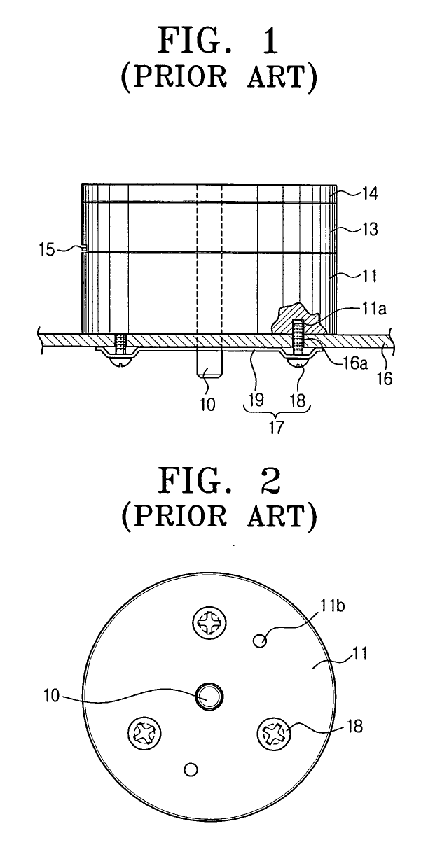

Throughout the drawing figures, like reference numbers will be understood top refer to refer to like elements, features and structures.

### DETAILED DESCRIPTION OF EXEMPLARY EMBODIMENTS

Certain embodiments of the present invention will be described in greater detail with reference to the accompanying drawings.

In the following description, the matters defined in the description such as a detailed construction and elements are exemplary implementations provided to assist in a comprehensive understanding of exemplary embodiments of the invention. Thus, it is apparent that various implementations of the embodiments of the present invention can be carried out without strict adherence to those defined matters. Also, description of well-known functions or constructions are omitted for conciseness and clarity.

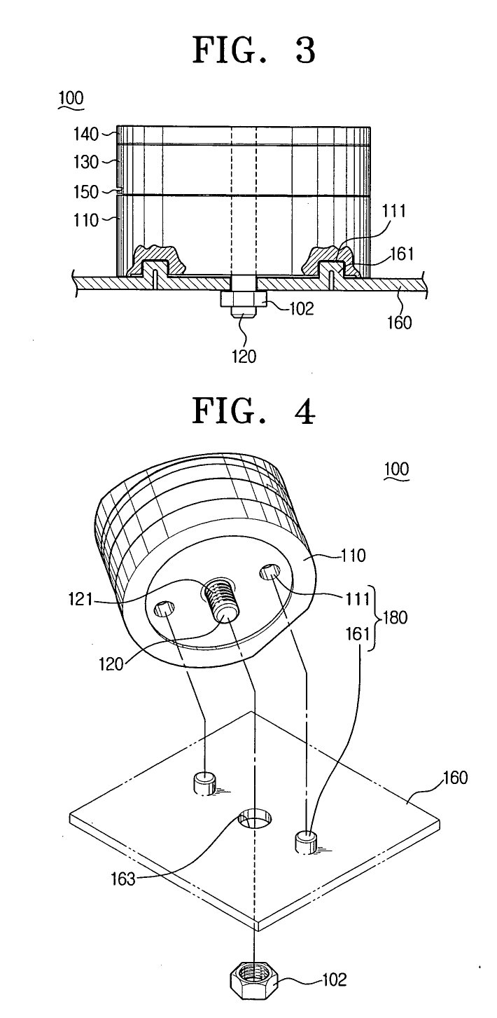

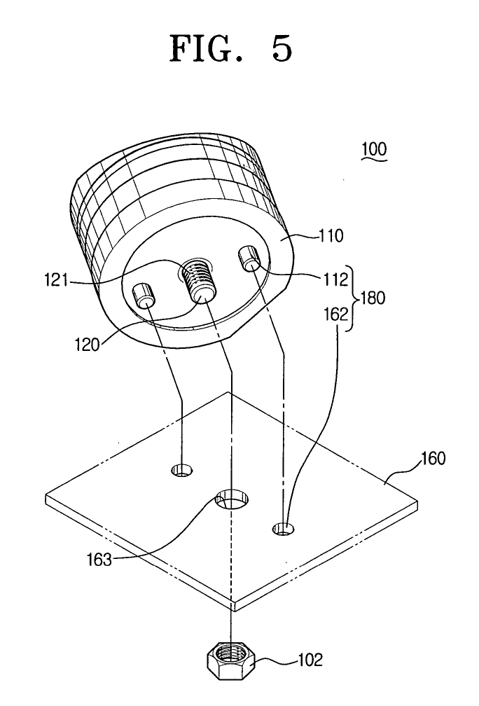

Referring to FIG. 3, a head-drum assembly 100 is rotatably mounted, being inclined at a predetermined angle with respect to a main chassis (not shown) where various parts of the magnetic recording/reproducing apparatus are mounted, so that the recording/reproducing performance can be improved.

The head-drum assembly 100 according to an embodiment of the present invention comprises a fixed drum 110, a shaft 120, a rotary drum 130, a drum base 160 and a connection housing 102.

The fixed drum 110 is fixed on the drum base 160 by the shaft 120, and the rotary drum 130 and a drum cover 140 are disposed in the upper part of the fixed drum 110.

The shaft 120 is forcibly fit into the fixed drum 110, and a connection unit 121 penetrating the drum base 160 is formed in the protrusion of the lower part of the fixed drum 110.

The rotary drum 130 is disposed in the upper part of the fixed drum 110 and it is supported to be rotatable by a bearing (not shown) on the shaft 120. The drum cover 140 which is connected to the shaft 120 with pressure is disposed in the upper part of the rotary drum 130, and a magnetic head 150 is set up to record data in magnetic tape or to reproduce the recorded data.

It is preferable that the drum base 160 is formed by bending a part of the main chassis to reduce the number of parts. However, the present invention is not limited to this, and it is possible to make the drum base 160 as, for example, a separate member and set it up on the main chassis. The fixed drum 110 is disposed on the drum base 160, and the connection unit 121 protrudes through an opening 163.

The connection housing 102 is connected with the connection unit 121 which penetrates the drum base 160 from the other side, through the opening 163. In accordance with an exemplary embodiment of the present invention, the connection unit 121 is a threaded bolt and the connection housing 102 is a threaded nut.

Therefore, since the threaded bolt 121 is connected with the threaded nut from the other side of the drum base 160 in order to set up the fixed drum 110 on the drum base 160, the number of parts for setting up the fixed drum 110 can be reduced and the time for setup can be shortened. Meanwhile, the head-drum assembly 100 for a magnetic recording/reproducing apparatus comprises a guide 180 for guiding the fixed drum 110 to its setup position.

As illustrated in FIGS. 3 and 4, in a first embodiment of the present invention, the guide 180 comprises a pair of guide bosses 161 formed in the drum base 160 and boss housings 111 formed in the fixed drum 110 at positions corresponding to the guide bosses 161. Herein, the guide bosses 161 can be formed as a separate unit, or according to an exemplary embodiment they may be integrally formed with the drum base 160 through a drawing process, which is illustrated in FIG. 3.

In accordance with a second embodiment of the present invention, the guide 180 comprises at least a pair of guide bosses 112 formed in the fixed drum 110 and boss housings 162 formed in the drum base 160 at positions corresponding to the guide bosses 161.

In accordance with the first and second embodiments, the guide bosses 161 and 112 and the boss housings 111 and 162 are symmetrically formed with each other with the shaft 120 at the center to guide the fixed drum 110 to its setup position easily.

The guide 180 prevents the fixed drum 110 from being rotated along the high-speed rotation of the rotary drum 130 from the initial setup position and helps the fixed drum 110 to remain in a predetermined position.

Meanwhile, although the first and second embodiments of the present invention show that the connection unit 121 and the connection housing 102 are implemented as a threaded bolt and a threaded nut, respectively, other implementations for securing connection unit 121 are within the scope if the invention. For example, it is possible to form connection housing 102 in the form of a pin to be connected with the connection unit 121. In this case, a pin opening is formed as the connection unit 121, instead of the screw bolt, so that the pin could be inserted into the pin opening. Thus, the connection unit 121 sets up the fixed drum 110 on the drum base 160 by inserting the pin into the pin opening formed as the connection unit 121 through the opening 163 formed in the drum base 160.

As described above, the head-drum assembly for a magnetic recording/reproducing apparatus sets up the fixed drum on the drum base by forming a connection unit at one end of the shaft which is inserted to the fixed drum with pressure, penetrating the connection unit through the drum base, and connecting the connection unit with the connection housing from the other surface of the drum base. Therefore, the number of parts and manufacturing processes required for setting up the fixed drum can be reduced, thereby saving the production cost as well.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A head-drum assembly for a magnetic recording/reproducing apparatus, comprising:
a fixed drum;
a shaft inserted into the fixed drum, the shaft comprising a connection unit protruding from a lower part of the fixed drum;
a rotary drum disposed with respect to an upper part of the fixed drum and rotatably supported by the shaft;
a drum base comprising an opening, an upper surface facing the lower part of the fixed drum, and a lower surface; and
a connection housing engaging at least a portion of the connection unit;
wherein the portion of the connection unit penetrates the opening of the drum base and extends beyond the lower surface of the drum base.

2. The head-drum assembly as recited in claim 1, wherein the connection unit comprises a threaded bolt, and the connection housing comprises a threaded nut.

3. The head-drum assembly as recited in claim 2, further comprising a guide for guiding the fixed drum to a setup position.

4. The head-drum assembly as recited in claim 3, wherein the guide comprises:
at least two guide bosses disposed on the upper surface of the drum base; and
at least two boss housings disposed on the lower part of the fixed drum at positions corresponding to positions of the guide bosses.

5. The head-drum assembly as recited in claim 3, wherein the guide comprises:
at least two guide bosses disposed on the lower part of the fixed drum; and
at least two boss housings disposed on the upper surface of the drum base at positions corresponding to positions of the guide bosses.

6. The head-drum assembly as recited in claim 4, wherein the positions of the guide bosses are symmetrical with respect to the shaft.

7. The head-drum assembly as recited in claim 4, wherein the guide bosses are integrally formed with the drum base.

8. A magnetic recording/reproducing apparatus comprising:
the head-drum assembly as recited in claim 1; and
a main chassis;
wherein the drum base is integrally formed with the main chassis, and the main chassis comprises components of the magnetic recording/reproducing apparatus mounted thereon.

9. A method of manufacturing a head-drum assembly for a magnetic recording/reproducing apparatus, the method comprising:
inserting a shaft into a fixed drum, the shaft comprising a connection unit at least a portion of the connecting unit protruding from a lower part of the fixed drum;
disposing a rotary drum on the shaft with respect to an upper part of the fixed drum, wherein the rotary drum is rotatably supported by the shaft;
placing the portion of the connecting unit protruding from the lower part of the fixed drum into an opening of a drum base, whereby an upper surface of the drum base faces the lower part of the fixed drum; and
connecting a connection housing to engage at least a portion of the connection unit protruding from a lower surface of the drum base.

10. The method of manufacturing the head-drum assembly as recited in claim 9, wherein the connection unit comprises a threaded bolt, the connection housing comprises a threaded nut, and the connecting of the connection housing comprises engaging a portion of the threaded bolt protruding from the lower surface of the drum base with the threaded nut.

11. The method of manufacturing the head-drum assembly as recited in claim 9, further comprising forming a guide for guiding the fixed drum to a setup position.

12. The method of manufacturing the head-drum assembly as recited in claim 11, wherein the forming of the guide comprises:
disposing at least two guide bosses on the upper surface of the drum base; and
disposing at least two boss housings on the lower part of the fixed drum at positions corresponding to positions of the guide bosses.

13. The method of manufacturing the head-drum assembly as recited in claim 12, wherein the positions of the guide bosses are symmetrical with respect to the shaft.

14. The method of manufacturing the head-drum assembly as recited in claim 12, wherein forming of the guide bosses comprises forming the guide bosses integrally with the drum base through a drawing process.
